(19) United States
(12) Patent Application Publication
(10) Pub. No.: US 2020/0240752 A1
(43) Pub. Date: Jul. 30, 2020

(54) INVISIBILITY CLOAKING DEVICE

(71) Applicants: Kumutha N, Virudhunagar, Tamilnadu (IN); Amutha N, Virudhunagar, Tamilnadu (IN)

(72) Inventors: Kumutha N, Virudhunagar, Tamilnadu (IN); Amutha N, Virudhunagar, Tamilnadu (IN)

(21) Appl. No.: 16/638,484

(22) PCT Filed: Aug. 9, 2018
(86) PCT No.: PCT/IN2018/000044

§ 371 Date: Feb. 12, 2020

(30) Foreign Application Priority Data
Aug. 14, 2017 (IN) 201741028806
Jul. 30, 2018 (IN) 201741028806

(51) Int. Cl. F41H 3/00; H01Q 17/00

(52) U.S. Cl. CPC F41H 3/00; H01Q 17/008

(57) ABSTRACT

The present invention relates to invisibility device in, particular to electromagnetic cloaking devices and their method of making the same. The present invention is related to designing the cloak device with a base made of first material and strips of second material placed on the said base. The present invention proposed a design strategy through which cloaking at multi band can be achieved even with single layer of cloaking device.

### TECHNICAL FIELD

The present invention described herein relates to an invisibility cloaking device and more particularly to an electromagnetic cloaking device. The present disclosure also relates to method of making of the said device.

### BACKGROUND

Electromagnetic (EM) cloaking technology is a stealth or camouflage technology that renders an object to be invisible to the Electro Magnetic (EM) spectrum. Various theories that are adopted in this technology are transformation optics as described in US20080024792A1, microwave network, active camouflage and scattering cancellation as described in US2015051417.

Recent research on EM cloaking technology is to make a wide-band and multi-band EM cloaking device. In US20110050360A1, EM resonators were arranged in a number of layers in order to achieve a wide band EM cloaking. In US20160111782A1, EM cloak structure comprises of a patterned metallic sheet with slits both in azimuthal and vertical directions utilizes two layers of cloak structure in order to achieve cloaking at two frequency bands. In US2015051417, Single layer dual-band EM cloak was achieved by loading electrical components on to the patterned metallic sheets.

In all the above said prior art, in order to achieve a wide or multi-band, either number of layers of patterned cloak structure were increased or cloak structures were loaded with other electrical elements. These methods are complex and may not be reliable as different components needs to work coherently. Also because of many components, manufacturing cost may go high and in some case it may not be violable also. The present disclosures aims at achieving a wide or multi band cloaking through single layer with less components involved.

### SUMMARY

The present disclosure relates to an invisibility cloaking device, in particular, to an electromagnetic cloaking device. The cloaking structure of the device comprises of single layer of plurality of array of strips placed over a base wherein the strips have the characteristics of either aperiodically placed strips or different geometries of strips or a combination thereof. The electromagnetic cloaking device as disclosed in present disclosure is capable of achieving a wide and/or multi-band cloak using a single layered cloak structure.

### BRIEF DESCRIPTION OF VISUAL ILLUSTRATION

The results and features of present invention are illustrated using graphs and drawings and are referred as “FIG.” followed by its numerical reference. Only figures that are most significant to illustrate the present invention are disclosed. However, the present disclosure is not limited to such figures alone. Following are the description or caption of those visual illustrations.

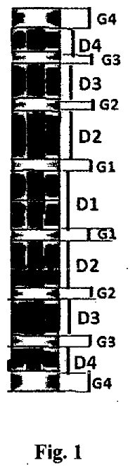

FIG. 1 depicts the proposed electromagnetic cloak structure.

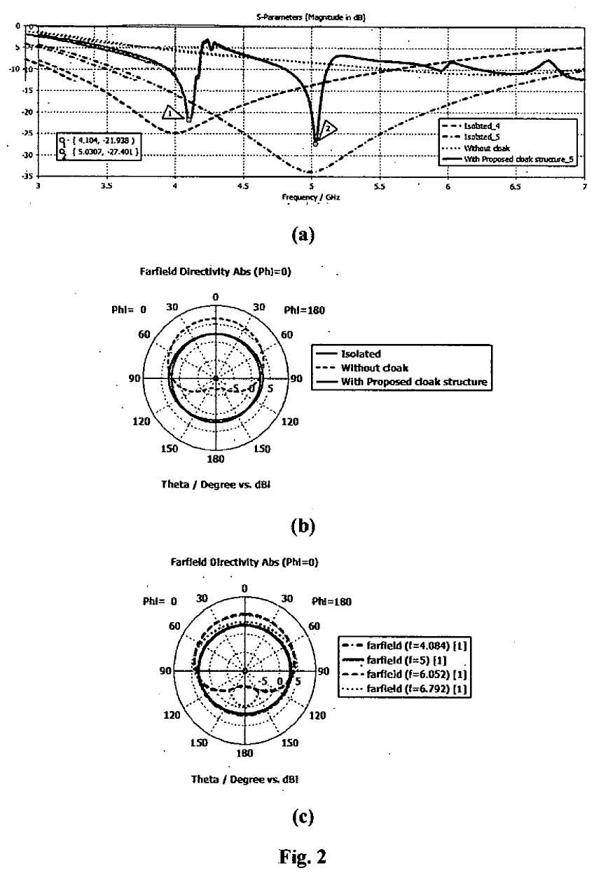

FIG. 2 shows the results of the proposed electromagnetic cloak structure (a) S₁₁ parameter (b) Radiation pattern for desired frequency (c) Radiation pattern for multiple frequencies.

### DETAILED DESCRIPTION

Hereinafter, the proposed electromagnetic (EM) cloaking will be explained in detail along with the method of making the same. The visual illustrations are referred wherever required while detailing the invention. It may be noted here that the invention thus disclosed is not limited either by following descriptions or embodiments.

The present disclosure is about an invisibility cloaking device, in particular, to an EM cloaking device. In an embodiment, the said cloaking device comprising a base and a plurality of arrays of one or more strips placed over said base wherein the strips are characterized by either different geometries or placing the strips aperiodically or a combination of both said characteristics.

In yet another embodiment, the device can be employed as a single layered multi-band cloaking device as the device can effectively cloak an object from radiation waves of sources operating at different frequencies. In yet another embodiment, the sources can be antennas of any type such as plane wave or directional antennas.

In yet another embodiment, the base and strips can be made out of either conductive or dielectric material but the materials used for both base and strips are not same.

### Best Method of Performing

Hereinafter, the proposed electromagnetic (EM) cloaking will be described with the best method of performing the said invention. It may be noted here that the description thus disclosed is not limited either by following descriptions or embodiments.

The object to be cloaked can be made of either a conducting or dielectric to material and is covered by a base made of dielectric or conducting material (first material) respectively. This cloaked object is illuminated by a TM/TE wave source.

### EXAMPLE 1

In this example, the base was made of first (dielectric) material and strips were made of second (conducting) material and the object made of conducting material was illuminated by TM wave sources using dipole antenna of 4 GHz.

The length and radius of the object which is to be cloaked is said to have 65 mm and 3.23 mm respectively. The total electric and magnetic fields including the incident and scattered field of the cloaked object in all its corresponding coordinate components were calculated. Applying the boundary conditions (for calculating unknown parameters), the scattered field impedance as the ratio of scattered electric and magnetic fields along the direction of propagation of incident wave was obtained as 390 Ω.

To make the above said object to be invisible to TM source, the said scattered impedance was compensated by the impedances of the plurality of arrays of one or more strips placed over the said base. By introducing the variations in compensated impedances, cloaking at multi bands in a single layer of base can be achieved. The variations in impedances can be obtained by the series connection of possible combinations of parallel RLC values. These lumped RLC values were converted to its distributed form. Thus, the variable impedances can be pronounced by the plurality of arrays of one or more strips with variable geometry placed over the said base or by placing strips aperiodically or both. The geometry variation of one or more strips or in their spacing or both can create impedance difference that leads to changes in phase velocity which finally varies the propagation path of the incoming wave reaching this geometry surface.

In this example, the cloak was designed to cloak the object at two different frequencies 4 GHz and 5 GHz. The number of strips required to cover the cloak was 4 based on the scattered field impedance of 390Ω. The clock radius was designed at 3.86 mm. The strips were placed over the base which is made up of dielectric material of dielectric constant as 10.2. The width of the strips is described as D1, D2, D3, and D4 as shown in FIG. 1. The gap between two strips or after strip was considered as periodicity and is designated as G1, G2, G3 and G4. respectively. The corresponding impedances of strips along with the gap were obtained and were found to be 274Ω, 377Ω, 697Ω and 2094Ω, respectively. From the said impedance value, the optimized width value of cloaking strip D1,D2,D3 and D4 at multiple bands was found out to be the geometrical variation of 10,8,6,4 respectively while keeping all the periodicity G1, G2, G3 and G4 of 2 as constant. Also, the significance in the plurality of arrays of one or more strips placed over said base counted from the middle of the said cloaking device will be derived from the vertical length of source.

The cloaking device as designed in example 1 was placed before the antenna source of 4 GHz. The results obtained are provided in FIG. 2a which shows the reduced return losses at 4.1 GHz and 5.0 GHz and radiation pattern in FIG. 2b and FIG. 2c clearly shows that the cloaking happened at those frequencies even with single layer of cloaking device.

I/We claim,

1) An invisibility cloaking device, comprising:
a base made of first material and a plurality of arrays of one or morestrips placed over said base wherein strips are made of second material; and the arrays have any one of following characteristics:
no strips placed in an array have a geometry similar to the strips placed in another array or arrays of strips are aperiodically placed or a combination thereof

2) The invisibility cloaking device as claimed in claim 1, wherein said device is an electromagnetic cloaking device.

3) The invisibility cloaking device as claimed in claim 1 or 2, wherein said device is a single layered multi band cloaking device.

4) The invisibility cloaking device as claimed in any one of claims 1 to 3, wherein first material is made out of dielectric material and second material is made out of conductivematerial or vice versa.

5) The invisibility cloaking device as claimed in any one of claims 1 to 4, scattered impedance of an object to be cloaked and the base is equal to impedances of the plurality of arrays of one or more strips placed over the base.
